(19) United States
(12) Patent Application Publication
(10) Pub. No.: US 2012/0054049 A1
(43) Pub. Date: Mar. 1, 2012

(54) TRACKING CHAIN-OF-COMMERCE DATA THROUGH POINT-OF-SALE TRANSACTIONS

(75) Inventor: Percy Randall Hayes, Richmond, TX (US)

(73) Assignee: EPoST Systems, LLC., Sugar Land, TX (US)

(21) Appl. No.: 12/868,892

(22) Filed: Aug. 26, 2010

(51) Int. Cl. G06Q 20/00; G07G 5/00; G06Q 10/00

(52) U.S. Cl. 705/21; 705/303; 705/302; 705/24

(57) ABSTRACT

Some embodiments include a method for processing information about products in a stream of commerce. The method can include recording unique identifiers in association with products; receiving, from a manufacturer of the products over a communications network, manufacturing information about the products; storing, in an electronic database, the manufacturing information in association with the unique identifiers; receiving, from entities in the stream of commerce over the communications network, additional information about the products; storing, in the electronic database, the additional information associated with the unique identifiers; receiving, over the communications network from retailers selling the products, consumer information identifying consumers of the products; and storing, in the electronic database, the consumer information in association with the unique identifiers.

### LIMITED COPYRIGHT WAIVER

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2010, EPoST Systems, LLC.

### TECHNICAL FIELD

Embodiments of the inventive subject matter relate generally to electronic commerce tracking systems that, more particularly, track commerce data through a chain-of-commerce.

### BACKGROUND

A chain-of-commerce is a process by which a product, or its components, moves from product creation to consumer purchase. Several entities may be involved in the chain-of-commerce including manufacturers, distributors, wholesalers, shipping companies, retailers, online businesses, consumers, etc. Currently, many of the businesses entities (“vendors”) involved in the chain-of-commerce track their own information regarding the product. For instance, vendors track activities for the product and for consumers that buy the product. Some vendors (e.g., retailers) have implemented consumer loyalty programs. A consumer can register for a consumer loyalty program by providing contact information. The vendor assigns the consumer an identification code (e.g., a bar code) that the vendor can use each time the consumer makes a purchase. The vendor tracks some information about the purchase in the vendor's system. The vendor further uses the purchase information and the consumer's contact information, to provide marketing offers to the consumer.

However, most business entities do not share tracked information with other business entities or with the consumer. The consumer may only see the marketing material provided by a vendor. Further, consumers typically register with different vendor loyalty programs. Therefore, a consumer may have multiple consumer loyalty program identities and multiple, disparate, purchasing histories that correspond to the many vendors. Consequently, any given vendor only has a snapshot, or subset, of a consumer's buying history related only to the purchase made from that particular vendor. Further, the consumer has none of this information and only benefits to the degree that each vendor wishes to share their subset of the consumer's buying history in order to provide special offers to the consumer.

Further, before a product reaches a retail vendor, the product must be created and supplied to the retail vendor by other vendors in the chain-of-commerce (“provider vendors”). The provider vendors may include distributors (e.g., wholesalers), supply companies (e.g., shipping companies, storage facilities, etc.), manufacturers, service providers, or any other individuals or business entities involved in providing the product to a retail vendor via the chain-of-commerce for a product. The provider vendors also track their own activities regarding the product (e.g. origin, shelf life, manufacturing history, components, serial or batch numbers, or other identifiers describing the origin, characteristics of functionality and combinations thereof). However, the provider vendors that provide or handle the product along the chain-of-commerce do not share their information with each other, with the retail vendors, or with consumers. In addition, each provider vendor only has a subset of information on the product and its relationship to each other vendor along the chain-of-commerce, and has no information about the consumer who purchases the product.

### BRIEF DESCRIPTION OF THE DRAWINGS

The present embodiments may be better understood, and numerous objects, features, applications, and advantages made apparent to those skilled in the art by referencing the accompanying drawings.

FIG. 1 is an example illustration of tracking commerce data for a product at various stages in a chain-of-commerce.

FIG. 2 is an example illustration of providing commerce-related services via the Internet or other communications pathway to a user account subscribed to a centralized chain-of-commerce computer service.

FIG. 3 is an example flow diagram 300 illustrating tracking commerce data for a product in a chain-of-commerce and providing commerce-related services using the commerce data.

FIG. 4 is an illustration of an example commerce tracking system architecture 400.

FIG. 5 is an illustration of an example commerce tracking computer system 500.

### DESCRIPTION OF ILLUSTRATIVE EMBODIMENTS

This description of the embodiments is divided into four sections. The first section provides an introduction to embodiments. The second section describes example operations performed by some embodiments, while the third section describes example operating environments. The fourth section presents some general comments.

The description that follows includes exemplary systems, methods, techniques, instruction sequences and computer program products that embody techniques of the present inventive subject matter. However, the embodiments may be practiced without these specific details. For instance, although examples refer to tracking a chain-of-commerce for a product, other embodiments may include tracking a chain-of-commerce for a service, a group of products, products combined with services, etc. In other instances, well-known processes, protocols, structures, and techniques have not been shown in detail in order not to obfuscate the description.

### Introduction

This section provides an introduction to some embodiments.

Some embodiments of the inventive system can track information about non-durable products that may be quickly consumed. Non-durable goods include food products (e.g., peanut butter), health products (e.g., eye drops), chemical products (e.g., cleaners, paints, etc.), fuel, personal products, clothing, paper and packaging products, etc. Typically, manufacturers do not track information about consumers who purchase particular non-durable goods. For example, a food manufacturer may not have information about consumers who buy particular jars of peanut butter. Thus, if the food manufacturer were to recall a batch of peanut butter (e.g., because the peanut butter posed health risks), the food manufacturer could not directly notify consumers who purchased the peanut butter. Instead, the food manufacturer would likely notify consumers via general public press releases and other media. Embodiments of the invention enable manufactures thru the inventive system to directly notify consumers who purchased (or otherwise procured) particular products. In some instances, manufactures can identify particular products (e.g., by a list of unique identifiers), and provide recall information to the system. In turn, the system can forward the recall information or other notices to consumers who purchased the particular products.

Some embodiments of the inventive system can track information about durable products. Durable products, which are expected to last longer than non-durable products, include machines and equipment, such as vehicles, watercraft, computers, aircraft, tools, appliances, home furnishings and fixtures, housewares, sporting goods, toys, games, apparel, etc. Durable products can also include spare machine parts and other machine components. Some embodiments enable manufacturers to notify consumers about issues relating to particular products the consumers have purchased. For example, embodiments of the system can receive, from manufacturers, notice information and lists of unique product identifiers. In turn, the system can transmit (e.g., via email, voicemail, etc.) the notice information to consumers who purchased the products identified by the unique product identifiers.

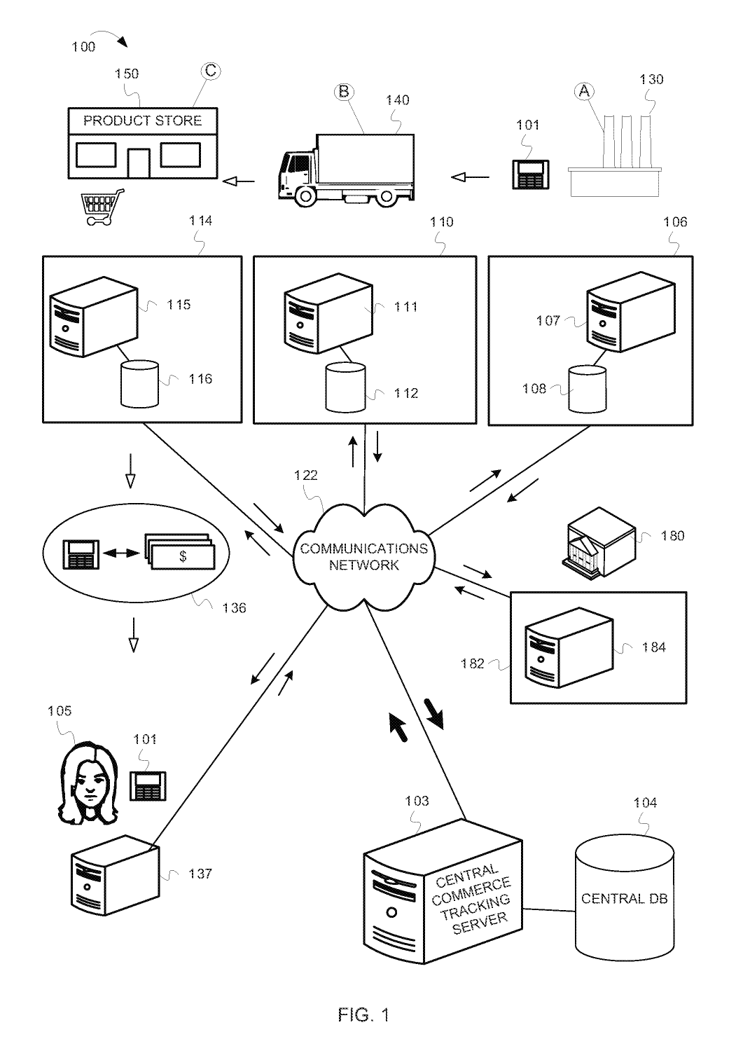

FIG. 1 is an example illustration of tracking commerce data for a product at various stages in a chain-of-commerce. In FIG. 1, a centralized chain-of-commerce tracking system (“system”) 100 is described. The system 100 can track and use commerce data associated with a chain-of-commerce. The system 100 tracks information about a product 101, information about a consumer 105, and information about other individuals or entities involved in the chain-of-commerce at various stages of interaction with the product 101 or the consumer 105.

A chain-of-commerce has multiple points, or stages (e.g., an origin stage “A,” a supply stage “B,” and a point-of-sale or transaction stage “C”), at which certain activities occur regarding the product 101 and that add to the products properties, history, path, characteristics, etc. The stages described in FIG. 1 are only some of the stages that a product may experience in the chain-of-commerce. There may be subsets of stages for creation, supply, offer, or purchase/procurement. Other stages not shown may include marketing stages, inventory stages, warehousing stages, etc. Every stage may have one or more accompanying activities. Some stages may have multiple activities. Some activities may repeat throughout the stages. For example, many stages may include purchase transactions that sell and resell the product 101, and where product ownership transfers, from one vendor to another vendor until finally reaching the final vendor that offers the product for sale to the consumer 105, in the point-of-sale or transaction stage “C.” The system 100 captures commerce data for each activity at each stage and stores the commerce data in a central database 104. For example, some of the information tracked by the system 100 may include, but is not limited to, some or all of the following: product manufacturer name, product manufacturing dates, product location, product lot or batch numbers, product model numbers, storage locations, shipping patterns, product inventory identifiers, product locations, product name, product brand, product size/color, product pricing, consumer identity or other consumer characteristics, consumer purchase history, consumer method of payment, time/place of purchase, register #, attendant/checker, other characteristics identifiable to a transaction or combinations thereof, etc.

Each point or stage in the chain-of-commerce may be associated with a subsystem (e.g., computers, networks, network devices, and other electronic mechanisms or communications pathways) that belongs to an individual or entity associated with the stage. For example, a first subsystem 106 belongs to a manufacturer entity (“manufacturer”) 130, such as a constructor, a fabricator, assembler, etc. of the product 101. The manufacturer 130 uses the first subsystem 106 to track data regarding manufacturing (e.g., construction, fabrication, assembly, packaging, etc.) of the product 101 at the origin stage “A.” The first subsystem 106 includes computer equipment (e.g., a computer 107 and a database 108) connected to a communications network 122. The manufacturer 130 uses the computer 107 to track data regarding its own activities in the database 108. A second subsystem 110 belongs to a supply entity (“distributor”) 140. The distributor 140 uses the second subsystem 110 to track data regarding distribution of the product 101 at the supply stage “B.” The second subsystem 110 includes computer equipment (e.g., a computer 111 and a database 112) connected to the communications network 122. The distributor 140 uses the computer 111 to track data regarding its own activities in the database 112. A third subsystem 114 belongs to a retail entity (“retailer”) 150. The retailer 150 uses the third subsystem 114 to track data regarding the purchase and sale of the product 101 at the point-of-sale or transaction stage “C.” The third subsystem 114 includes computer equipment (e.g., a computer 115 and a database 116) connected to the communications network 122. The retailer 150 uses the computer 115 to track data regarding its own activities in the database 116. Thus each of the stages includes computer activity from the computers 107, 111, and 115 that read and/or write commerce data (e.g., makes database transactions of the commerce data) to each database 108, 112, 116. The computers 107, 111, and 115, however can perform additional activity that sends the commerce data to a central commerce tracking server (“central server”) 103 to store in the central database 104. The central server 103 and the central database 104 may be owned, operated and/or controlled by a company that tracks data at all of the stages of the chain-of-commerce. Using the central server 103, the company can provide a computer service to which all of the subsystems 106, 110, 114 can be subscribed for commerce related services. The computer service can monitor the activities that occur on the subsystems 106, 110, and 114 to detect when commerce data is transacted to the databases 108, 112, and 116. In response, the computer service can automatically send the commerce data to the central server 103 for storage on the central database 104. In some embodiments, individuals or entities in the chain-of-commerce can upload certain information (e.g., via a web or other communication interface, via spreadsheet, via database record push, etc.). In some embodiments, the central server 104 requests (pulls) and transmits (pushes) database transaction data to and/or from the component databases (i.e., databases 108, 112, and 116).

As stated previously, the system 100 can capture commerce data from various activities that occur at each stage in the chain-of-commerce. The following are just a few examples of activities that each of the individuals or entities may track and store using the subsystems 106, 110, 114. At the origin (stage “A”), the manufacturer 130 may perform one or more of the following activities and track data regarding the performance of such activities:
The manufacturer 130 may create the product 101 (e.g., form, assemble components or ingredients). While creating the product 101, the manufacturer 130 may track any one or more of information on sources of components for the product 101, a location of creation or assembly for the product 101, a date of creation for the product 101, crew members that assemble or create the product 101, lot/batch numbers for a raw form of the product 101, etc. Component providers (i.e., the entities that provide the components or ingredients to the manufacturer 130) have information for all of the components or ingredients. In some embodiments, the component providers can also have accounts for the system 100 and can provide their information to the central server 104. In other embodiments, the manufacturer 130 can enter the information from the component providers into the system 100.
The manufacturer 130 may mark or encode the product 101 with a unique identifier to allow traceability thru the identified subsystems.
The manufacturer 130 may perform quality control on the product 101.
The manufacturer 130 may package the product 101. The packaging of the product may include tracking any one or more of a label on the product 101, packaging material for the product 101, the source of packaging material, a date of packaging the product 101, etc.
The manufacturer 130 may organize the packaged product 101 into lots or batches.
The manufacturer 130 may assign a suggested retail price or assign a manufacturer's price to the product 101.
The manufacturer 130 may receive orders for the product (e.g., from the distributor 140, from the retailer 150, etc.).
The manufacturer 130 may prepare the product 101 for shipping.
The manufacturer 130 may service, repair, or replace the product 101.
The manufacturer may recall a product, where such a recall includes providing notice that the product 101 may be tainted, unsafe, or defective; such a recall may also include a list of instructions, such as how to dispose of the product 101, return the product 101, repair the product 101, etc.

At the supply stage “B,” the distributor 140 may perform one or more of the following activities and track data regarding the performance of such activities:
The distributor 140 may receive or obtain (e.g., pick up) the product 101 from the manufacturer 130.
The distributor 140 may store the product 101.
The distributor 140 may track details of product 101 (e.g., weight, size, type, quantity, # of days on shelf, etc.).
The distributor 140 may assign a wholesale price to the product 101.
The distributor 140 may receive or make orders for purchase or sale of the product 101.
The distributor 140 may perform additional assembly to the product 101 or associate the product 101 with an additional product.
The distributor 140 may package or repackage the product 101.
The distributor 140 may market the product 101.
The distributor 140 may service, repair or replace the product 101, or identify such product 101 as tainted, unsafe or defective.
The distributor 140 may sort the product 101 for delivery.
The distributor 140 may transport the product 101. While transporting the product 101, the distributor 140 may track any one or more of transportation locations, scheduled delivery dates and times, actual delivery dates and times, name of recipient, quantity delivered, transportation tracking identifiers, etc.
The distributor 140 may deliver the product 101 to the retailer 150.

At the point-of-sale or transaction stage “C” the retailer 150 may perform one or more of the following activities and track data regarding the performance of such activities:
The retailer 150 may receive the product 101 from the distributor 140 or manufacturer 130.
The retailer 150 may store the product 101 in inventory and assign a shelf date.
The retailer 150 may receive and/or place of orders for the product 101.
The retailer 150 may assign a retail price to the product 101.
The retailer 150 may market the product 101.
The retailer 150 may service, repair or replace the product 101, or identify such product 101 as tainted, unsafe or defective.
The retailer 150 may sell or perform a purchase transaction 136 of the product 101 (e.g., scan a code or product identifier such as an universal product code, capture a detailed description of the product (e.g. size, color, brand, product name), track the register, track the sales person, track the time/place of purchase, track the date of purchase, track the type of payment, track a number of items purchased, track the return/exchange policy attributable to the product, track the price of the product and calculated taxes attributable to the purchase, etc.)
The retailer 150 may associate the purchase transaction 136 with a particular consumer loyalty account.
The retailer 150 may obtain consumer contact information (e.g., scanning an RFID identifier or identification device for the consumer, updating consumer contact information via a consumer loyalty account, etc.).
The retailer 150 may track the method of payment and communicate with a financial institution or credit issuer and associate such information with the consumer 105.

In some embodiments, the central server 103 analyzes commerce data from the subsystems 106, 110, and 114 and may provide commerce-related services related to the chain-of-commerce (e.g., generate receipts, report information, produce notifications, etc.) to the various individuals or entities involved in the chain-of-commerce. The central server 103 can provide certain commerce-related services via the subsystems 106, 110, and 114. The system 100 can also provide commerce-related services to the consumer 105 via a personal computer 137, a cell phone, or any other device that can communicate with the central server 103 via the communications network 122.

In some embodiments, the central server 103 can also provide commerce-related services to an interested third party entity (“third party”) 180 that is not directly involved in the chain-of-commerce (i.e., an entity that does not directly interface with the product 101), but that may have an interest in or is responsible for knowing certain information about the product 101 or the consumer 105. The third party 180 can subscribe to the commerce-related services provided by the central server 103 and receive limited content related to the commerce-related services via a third-party system 182, which may include a computer 184. The third party 180 may be one of, but is not limited to, the following:
a regulatory body, governmental body, first responder (e.g., responsible for tracking recalls or known product safety or defect issues or emergencies, or tracking of commerce data involving electronic benefit transfers);
an attorney or law firm (e.g., responsible for notifying consumers of class action lawsuits or product safety or defect law suits, etc.);
a repair service provider (e.g., responsible for servicing warranty items);
an identity tracking company (e.g., responsible for verifying and authenticating a consumer);
law enforcement or security agencies (e.g., responsible for tracking illegal activities regarding products);
marketing companies (e.g., responsible for marketing products to consumers);
financial institutions, credit issuers, corporations (e.g. responsible for tracking employee purchases), benefits administrators (e.g. responsible for administering flexible benefit programs, etc.

This discussion refers to “products.” In some instances, the term “products” refers to goods, items or item components, which may be animate, inanimate, tangible, or intangible, durable or non-durable. Furthermore, in some instances “products” refers to any type of renderable service or other event of recordable commerce.

This discussion also refers to a “consumer or “consumers.” In some instances a consumer is as an acquirer or end user (or agent of an acquirer or end user) of any product in a transaction, in whole or in part, including a donor in situations where the transaction results in a gift, exchange, charitable donation (in cash or in kind), etc.

This discussion also refers to embodiments that “track” data. In some instances, tracking can include actions involving the using, integrating, interpreting, analyzing, exporting, capturing, storing, manipulating, distributing, sharing, controlling, retrieving, reviewing, filtering, organizing, reporting, sorting, packaging, presenting, or downloading.

The discussion also refers to a “chain-of-commerce.” In some instances, the chain-of-commerce includes events and activities occurring from the point of product creation to product procurement. The product can be involved in any suitable transaction type, including purchase, barter, exchange, gift, donation, or other exchanges of value where ownership of a product or service is conveyed from one party to another.

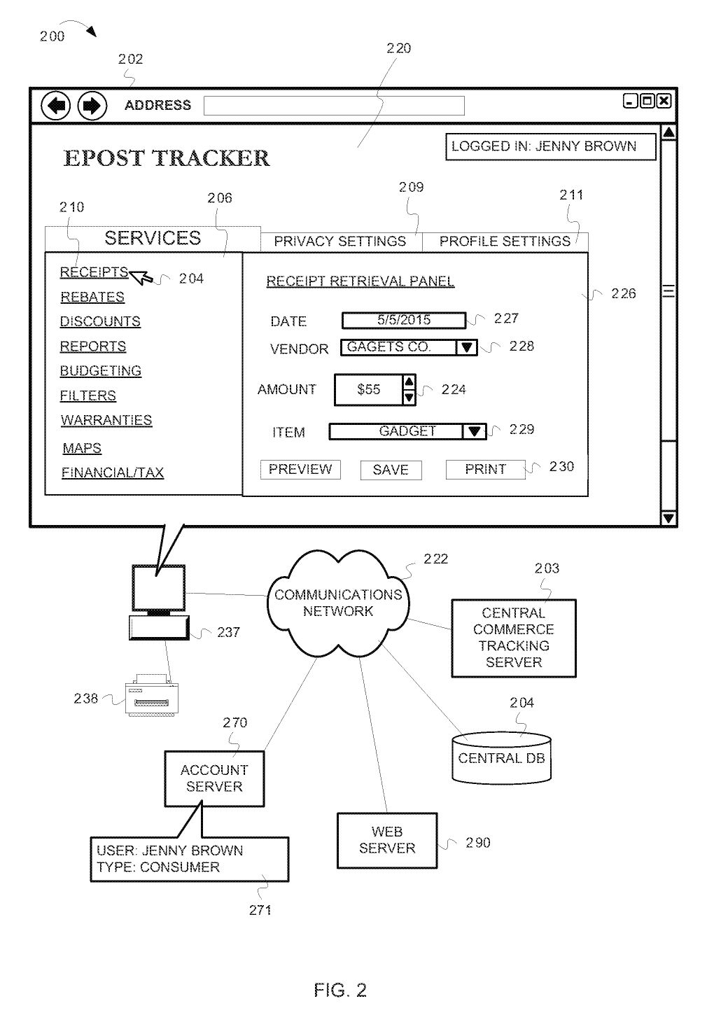

Although FIG. 1 describes some embodiments, the following sections describe many other features and embodiments. For example, the discussion of FIG. 2 (below) shows one example of a providing the commerce-related services described above.

### Example of Providing Commerce-Related Services via the Internet to a User Account Connected to a Centralized Chain-Of-Commerce Computer Service

FIG. 2 is an example illustration of providing commerce-related services via the Internet or other communications pathway to a user account subscribed to a centralized chain-of-commerce computer service. In some embodiments, a user that uses the user account was involved in transactions for products in a chain-of-commerce.

In FIG. 2, a centralized chain-of-commerce tracking system (“system”) 200 includes a computer 237 connected to a central commerce tracking server or network consisting of multiple central servers (“central server”) 203 via a communications network 222. The central server 203 accesses a central database 204 via the communications network 222 or via one or more other networks not shown. The computer 237 connects to a printing device 238. The central server 203 may be owned, operated and/or controlled by a company (e.g., EPOST Systems, LLC) that will track, retain and distribute all commerce data involved in a chain-of-commerce. The company may provide a website 220 hosted by a web server 290. The web server 290 can be associated with an account server 270 that stores a user account 271 associated with a user (e.g., user, Jenny Brown) that is subscribed to a centralized chain-of-commerce computer service (“computer service”). The central server 203 provides the computer service. The computer service provides content (e.g., receipts, reports, notifications, applications, etc.) to the user related to commerce-related services. In one embodiment, the web server 290 provides the content to the computer 237, which presents the content in a web browser 202 via the website 220. The user (e.g., Jenny Brown) may use the computer 237 to open the website 220 in the web browser 202. The user can log in to the user account 271 via the website 220. The website 220 can present a services menu 206 that provides content for various types of commerce-related services available to the user account 271 depending on a type of the user account 271 (e.g., consumer, distributor, manufacturer, third-party, etc.), as well as a subscription level for the user account 271. The services menu 206 can include links to content for commerce-related services that the user selects and is searchable based upon multiple criteria. When the user selects one of the links (e.g. link 210) in the services menu 206, the website 220 presents a content panel 226. The content panel 226 presents content (i.e., organized commerce data, reports, notifications, coupons, charts, etc.) for the service selected from the services menu 206. For example, the user selects the link 210 associated with receipt retrieval (e.g., clicks on link 210 using a mouse cursor 204), so that the user can access old receipts for past purchases previously tracked by the central server 203. After the user selects the link 210, the website 220 presents in the content panel 226 several controls that the user can use to search for a specific receipt for a specific product purchased on a specific date or range of dates. For example, the content panel 226 includes a purchase date control 227 that the user can use to select a date or range of dates on which the product was purchased. Based on the date(s) specified in the purchase date control 227, the central server 203 can provide any number of vendors from which the user (i.e., Jenny Brown) made purchases on the date or range of dates. The content panel 226 can present a dropdown menu for a vendor selection control 228 populated with the vendors at which the user made a purchase for the purchase date(s). The system 200 can detect a selection, via user input of the vendor selection control 228, of a particular vendor that may be associated with the date in the purchase date control 227. In some instances, a user may not know a specific date or range of dates, but may know the vendor from which a product was purchased. Instead of selecting the date first, the user may select the vendor first. The menu associated with the vendor selection control 228 may include a list of all vendors from which the user has ever purchased a product tracked by the system 200. In some embodiments, the system 200 detects that a user enters a dollar amount or amount range in a dollar amount control 224, or selects an item description from an item description control 229. In some embodiments, the user controls specified may be search fields in which a user can type in search terms or search criteria regarding the product and/or transaction. In some embodiments, the search may include Boolean operators and/or filtering or sorting capabilities for types of vendors, products, etc. (e.g., search by vendor type, product type, etc.). Once a product or transaction has been found using the controls in the content panel 226, the user may view or print a report about data associated with the product or transaction. In some instances, the user may view or print a graphical image (e.g., a JPEG), a document (e.g., an Adobe™ Portable Document Format (PDF) document), or other representation of a transaction receipt (e.g., via the print button 230 which sends the representation of the receipt to the printer 238).

Receipt search and retrieval content is only one type of content that a user can obtain via the system 200. The system 200 can provide a variety of content for commerce-related services. The content for the commerce-related services vary based on a type of user and subscribed level of service. For example, the system 200 may provide content from commerce-related services for a consumer or consumer type of user account regarding or more of the following:
warranty information;
return/exchange policy information attributable to a product and vendor
rebate information;
gift card information (e.g. balances by vendor)
purchase history reports;
maps or directions to service providers;
warning information or notifications of product safety or product defects, emergencies or recalls;
product history data filters;
financial and tax planning services;
budgeting charts;
transaction/financial spending limitations (e.g. by vendor, product, method of payment, time period)
etc.

In another example, the website 220 may present content for commerce-related services for other types of user accounts regarding one or more of the following:
recall information;
marketing information by type of demographic (e.g., gender, age, etc.), location (e.g., by zip code, by state, by store, etc.), purchase method (e.g., cash, card, etc.), other financial factors (e.g., prices, discounts, etc.), etc.;
rebate and discount documents or design tools;
product improvement reports;
product manufacturing data;
warranty information;
financial planning applications;
project or product management applications or calendaring;
etc.

In some embodiments, the website 220 provides a privacy settings menu 209 and a profile settings menu 211 that allows certain commerce related information to be filtered at the discretion and control of the user. The system 200 can detect when a user selects the privacy settings menu 209 and sets privacy levels for sharing, providing or receiving certain information contained in or associated with a user account 271. For example, the entity associated with the user account 271 may not want to receive any information available from other entities in the chain-of-commerce or from third parties that subscribe to the computer service provided by the central server 203. For instance, a consumer type of user can set privacy levels that would prevent certain third-party marketers from having contact information for the user or from sending certain types of marketing material via email, mail, mobile phone, etc., while allowing the receipt of such information (e.g., recall information) from certain others. In another instance, a manufacturing user can set a level of granularity to filter the type of information shared by the manufacturing user with other users (e.g., may set privacy levels regarding product properties that may reveal trade secrets if shared with others, may set privacy levels on financial data or pricing set by the manufacturer, etc.). Further, the system 200 can detect that a user selects the profile settings menu 211 to change contact information, user account information, subscription levels, credit/debit card or payment information, etc. In another instance, a consumer user may establish financial spending limits (for any given time period) based upon financial/budgeting goals for categories of products, particular vendors, or particular methods of payment. The system 200 can detect when a user exceeds such predetermined limits, and provide a notification to the consumer at the point-of-sale if it is about to exceed such limits and will terminate the transaction. The system 200 can also detect that these notifications can be overridden by the consumer prior to consummating the transaction.

### Example Operations

This section describes operations associated with some embodiments. In the discussion below, some flow diagrams are described with reference to block diagrams presented herein. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). Moreover, some embodiments can perform more or less than all the operations shown in any flow diagram.

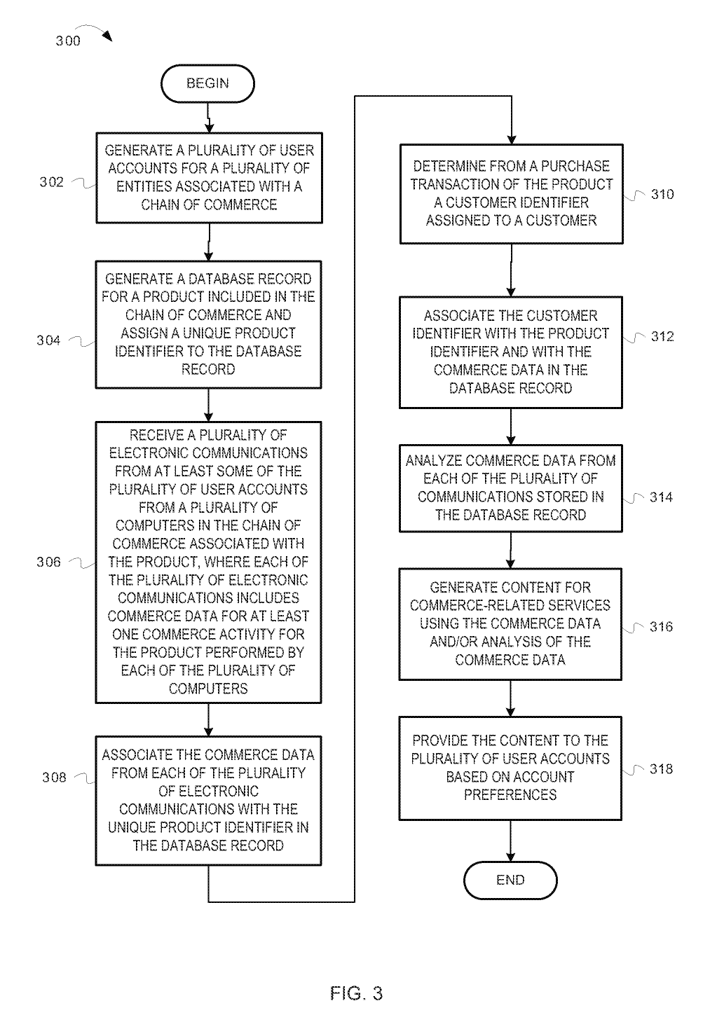

FIG. 3 is an example flow diagram (“flow”) 300 illustrating tracking commerce data for a product in a chain-of-commerce and providing commerce-related services using the commerce data. In FIG. 3, the flow 300 begins at processing block 302, where a centralized chain-of-commerce tracking system (“tracking system”) generates a plurality of user accounts for a plurality of individuals or entities associated with a chain-of-commerce. As indicated previously, the plurality of individuals or entities may be any of the vendors, manufacturer, the consumer, or interested third parties. Each of the entities can be required to register or subscribe for a user account maintained by the tracking system. For example, the tracking system can receive user registration information (including contact information, preferences, etc.) for each user account and generate user profiles for each user account. The registration information may vary based on type of user (e.g., consumer, vendor, manufacturer, shipper, wholesaler, retailer, e-tailer, etc.) but may generally include for all users one or more of the following:
profile and/or contact information (user account identifier, name, email addresses, phone numbers, mailing addresses, etc.);
preferences (e.g., privacy levels, marketing preferences, preferred formats for specific types of communications, etc.); and
subscription information (e.g., subscription levels for commerce-related services, payment agreements, etc.).

The flow 300 continues at processing block 304, where the manufacturer generates a database record for a product included in the chain-of-commerce and assigns or records a unique product identifier to the database record. According to some embodiments, the system can accept a manufacturer's unique product identifier, or the system may generate the unique product identifier. In some instances, the tracking system can generate the database record in response to an electronic communication received from a point of origin for the product (e.g., from a manufacturer for the product). The manufacturer may not assign a unique identifier to the product until packaging (or after other processes have occurred), but the tracking system can track information about the product even before the manufacturer assigns the unique identifier. For instance, the product may be part of a product batch, and the manufacturer may provide an electronic communication that indicates a batch number and a number of raw products associated with the product. The tracking system can generate a database record for each of the number of raw products indicated in the batch. After the manufacturer screens the raw product for quality assurance and sends the inspected product to be packaged, the tracking system can verify the number of inspected products assigned to the batch (minus any discarded raw products during quality assurance screening), and assign the unique identifiers to each of the database records for the products that need packaging. However, between creation of the product and packaging, the tracking system can still track information on each of the products in the central database until receiving the unique identifier from the manufacturer. If the manufacturer assigns the product a unique identifier, such as a universal product identifier (a universal product code plus additional coding to identify the unique item) at a point of origin, then the tracking system can use the universal product identifier as the unique product identifier, or associate the universal product code with the unique product identifier in the database record. In some embodiments, however, the tracking system can provide the unique product identifier to the manufacturer. Therefore, in some embodiments, the tracking system can assign the unique identifier at the beginning of the product's life without having to wait for an assignment by the manufacturer at packaging. The tracking system can store product profile information in a database that is independent of each entity in the chain-of-commerce, but applicable to all of the entities. At each stage, or point, in the chain-of-commerce, the tracking system writes any commerce data for the product to the same database record in the central database.

The flow 300 continues at processing block 306, where the tracking system receives, from a plurality of computers in the chain-of-commerce associated with a product, a plurality of electronic communications from at least some of the plurality of user accounts, where each of the plurality of electronic communications includes commerce data for at least one commerce activity for the product performed by each of the plurality of computers. The electronic communications can come from tracking activities performed by any of the individuals or entities in the chain-of-commerce. For example, as described previously at processing block 304, the manufacturing entity can provide a first electronic communication at the origin point for the product. Further, as described previously at processing block 302, each entity can register for a user account. The entity, or user, belonging to the account can log in to the user account before performing any activity associated with the product. Thus, the system can track commerce data for each electronic transaction or activity performed by the applicable user via the user account. The user's computer transfers the commerce data in the electronic communications via the tracking system, for example, as described in FIG. 1.

Certain entities may have equipment that scans the product identifier (e.g., on the packaging, on a manifest for the product, etc.), using a scanning technology (e.g. barcode, RFID, etc), during each activity, or batch of activities, that the entity performs on the product. In other embodiments, however, the product can have an RFID chip, or a batch representative can have an RFID chip, that contains the product identifier for the product. Each computer for the entity can detect and communicate the product identifier and send the product identifier, along with commerce data for the product, to the central server in the tracking system. The commerce data includes information for the commerce activities performed to, or for, the product, along with any peripheral or secondary information associated with the activities or the product. In some instances, computers accumulate commerce data and transfer it in bulk.

The flow 300 continues at processing block 308, where the tracking system associates the commerce data from each of the plurality of electronic communications with the unique product identifier in the database record. The tracking system can generate database transactions that write and/or relate the commerce data to the central database for the database record assigned to the product. The tracking system can also determine a vendor identifier (e.g., receive in the electronic communication a vendor identifier, use a vendor identifier associated with a user account, etc.) and associate (e.g., relate in the central database) the vendor identifier with the commerce data that comes from the vendor. Thus, the tracking system can identify and associate each portion of commerce data with a specific vendor entity.

The flow 300 continues at processing block 310, where the tracking system determines, from a transaction of the product, a consumer identifier assigned to a consumer. In some embodiments, the tracking system determines the consumer identifier at a purchase transaction associated with the point of sale for the product. In some embodiments, the tracking system can detect a scan of a unique consumer identifier device (e.g., a credit card, a consumer loyalty card, a radio-frequency identifier (RFID) device assigned to the consumer, etc.) at the point of sale. In some embodiments, the unique consumer identifier device may include a key-chain RFID chip, or a card with carbon nanotube ink that functions as an RFID device. The consumer identifier can be encoded into the specific consumer device. The vendor can detect the consumer identifier from the specific consumer device at a point of sale using specific detection equipment. For online type sales, in one embodiment, the consumer may use computer embedded identification technology as detection equipment to detect the consumer identifier from a specific consumer device. In some embodiments, a consumer may be required to activate and verify key customer info to the central tracking server (e.g., see FIGS. 1, 103 and 104, etc.) to associate consumer identification information with the product. The tracking system can retrieve the consumer identification information from the key consumer information such as an on-line identification and password to ascertain the consumer identifier that the tracking system uses to track the consumer.

In other embodiments, the tracking system can detect the consumer identifier by a consumer verification procedure (e.g., consumer logs in to a user account prior to the purchase transaction) through which the consumer provides the consumer identifier or provides access to the user account from which the tracking system can obtain the consumer identifier. The tracking system can personally verify a consumer before a purchase transaction. The tracking system can require the consumer to enter a password to verify or authenticate the consumer. For example, the tracking system can require a password and login name to access the user account via a graphical-user-interface at the point of sale (e.g., a login interface at a checkout register). The tracking system can use the password as the authentication for the user. In some embodiments, the tracking system can require a biometric scan for the consumer at the point of sale (e.g., a fingerprint scanner, a retinal scanner, a voice detector, a facial recognition scanner, etc.). In some embodiments, the point of sale system can include a PC, PDA, smart phone, etc.

The flow 300 continues at processing block 312, where the tracking system associates the consumer identifier with the product identifier, the vendor identifier and with the commerce data in the database record. For instance, the tracking system can write and/or relate the consumer identifier with the product identifier and vendor identifier associated with the database record. In some embodiments, the tracking system writes an entry into the database record in a key variable that relates the database record from a product database table to a consumer database table. In some embodiments, the tracking system associates or relates transaction receipt information with the product identifier. Thus, subsequently, the tracking system can generate an electronic copy of a transaction receipt (or other transaction report) that a consumer or vendor can access via the Internet or by direct communication link to another communication pathway (e.g., see FIG. 2). The tracking system can also, break out each product on the receipt (or other transaction report) into separate entries so that the user account can search per product. The tracking system can present searched data for separate products in a graphical user interface (e.g., see FIG. 2). The tracking system can present the copy of the transaction receipt via the graphical user interface, via an email message, or in another way requested by the user account. In another example, the tracking system can associate commerce data with registration programs (e.g., warranty registration, rebate registration, etc.) associated with the product. Thus, the tracking system can automatically register the consumer with the registration programs.

In some embodiments, the tracking system can detect a consumer's predetermined financial spending limits (for any given time period) based upon financial/budgeting goals (e.g., for categories of products, particular vendors, or particular methods of payment), detect when a consumer exceeds such predetermined limits, and provide a notification to the consumer at the point-of-sale if the transaction will exceed such limits. In some instances, the tracking system will terminate the transaction. The tracking system can also detect that the notification and termination are overridden by the consumer. In other embodiments, the tracking system can receive a notification about a potential purchase of a product, wherein the notification identifies a potential buyer. The system can determine, based on the notification, financial spending limits associated with the potential buyer, wherein the financial spending limits are set by the potential buyer and not creditors. The system can determine that the potential purchase will exceed the financial spending limits if the potential purchase is completed, and it can present a notification indicating that the financial spending limits will be exceeded if the potential purchase is completed.

The flow 300 continues at processing block 314, where the tracking system analyzes the commerce data from each of the plurality of communications stored in the database record. The tracking system can analyze the commerce data in relation to the consumer entity (e.g., using the consumer identifier), the vendor entity (e.g., using a vendor identifier), or the product (e.g., using the product identifier). For example, the tracking system can process advanced analytic algorithms or applications that mathematically organize, analyze or interpret the commerce data. The tracking system can limit the degree of analysis based on privacy preferences from each of the user accounts. The tracking system can use the privacy preferences when obtaining user data from external, or third-party, databases related to the user (e.g., from vendor consumer loyalty databases, from consumer identity databases, from credit card issuer/financial institution databases, etc.).

The flow 300 continues at processing block 316, where the tracking system generates certain content for commerce-related services using the commerce data and/or analysis of the commerce data. The content may for example, include, or be related to, one or more of the following:
The tracking system can provide marketing content.
The tracking system can provide copies of transaction receipts.
The tracking system can provide warranty content.
The tracking system can provide content about preferred vendors who can service products still under warranty.
The tracking system can print a label with an address where a manufacturer can replace a product.
The tracking system can transfer warranty content from a vendor going out of business to a competitor that wants to purchase that warranty content
The tracking system can provide recall content. For instance, the tracking system can proactively send recall notifications and warnings to all parties that possess or have handled a product, including chain-of-commerce parties and third parties in a format required or requested by each party. For instance, a regulatory or governmental body may require a notification in a formal document, whereas a consumer may only request a notification via an informal email.
The tracking system can provide budgeting content.
The tracking system can provide tax content (e.g., sales tax, excise tax, charity expenditures, etc.).
The tracking system can provide financial content.
The tracking system can provide inventory-tracking content.
The tracking system can provide credits, rebates, refunds, discounts, coupons, return/exchange policies, etc.
The tracking system can provide identity information to identification companies that are tracking consumers and protecting consumer identities.
The tracking system can provide security related content.
The tracking system can convey credit approval.
The tracking system can provide regulatory notifications.
The tracking system can provide limits, filters, and reports for business credit/debit card transactions by employees based on settings set by employers.
The tracking system can provide expense reports for employees.
The tracking system can provide discounts for shopping services based on shopping history.
The tracking system can provide shopping related lists that help to optimize a consumer's shopping plan. For example, the tracking system can provide a list of vendors that have all products on a consumer's shopping list. In another example, the tracking system can provide a name of a vendor that has the most products on a consumer's shopping list. In another example, the tracking system can provide a summary of costs by a vendor for products on a shopping list, and so forth.
The tracking system can provide data mining (e.g., tracking a history of transactions to generate notifications for product maintenance or categorical analysis of purchases).
The tracking system can integrate with an entity's calendaring software, project planning software, financial/tax planning software, product development software, etc., to assist in scheduling activities related to products and entities.
The tracking system can establish transaction/financial spending limits for users of the tracking system. The spending limits can be for products, vendors, methods of payment, time periods, etc. The system can provide notifications if established limits are exceeded. The spending limits may be defined by consumers, the tracking system itself, entities in the chain-of-commerce, etc.

The flow 300 continues at processing block 318, where the tracking system provides the content to the plurality of user accounts based on account preferences. One example of providing the content for commerce-related services includes presenting content (e.g., receipts, documents, files, search engines, reports, notifications, messages, charts, etc.) via a graphical user interface. Other examples of providing content for commerce-related services may include mailing or e-mailing content to the individuals or entities associated with the user accounts or to third parties interested in the data (e.g., mail a coupon to a social contact specified in a user account).

In some embodiments, the tracking system can filter types of content for disclosure of commerce-related services based on preferences (e.g., based on do not call, or do not email settings). The tracking system provides a user account capabilities to control the disclosure of their own tracked data. Before, with consumer loyalty programs, for example, a consumer did not have an ability to control the information provided to a vendor or received from a vendor regarding the consumer loyalty data or purchase history. However, the tracking system provides the consumer the discretion and ability to control aspects of commerce data that the consumer provides via purchases of the product.

Further, as mentioned previously, user accounts can also be third parties interested in the content, as mentioned in FIG. 1. For instance, for a recall, a regulatory or governmental body may need to know the recall information. The tracking system can automatically provide a notification of the recall information in a format required by the regulatory or governmental body based on a specified preference by the vendor responsible for sending the notification or on a specified preference set by the regulatory or governmental body.

In some embodiments, the operations can be performed in series, while in other embodiments, one or more of the operations can be performed in parallel. For example tracking system can generate a database record concurrent with receiving a first electronic communication associated with a creation or assembly of the product. In another example, the tracking system may generate commerce-related services concurrently with analyzing commerce data.

### Example Operating Environments

This section describes example operating environments, architectures, systems and networks, and presents structural aspects of some embodiments.

### Example Commerce Tracking System Architecture

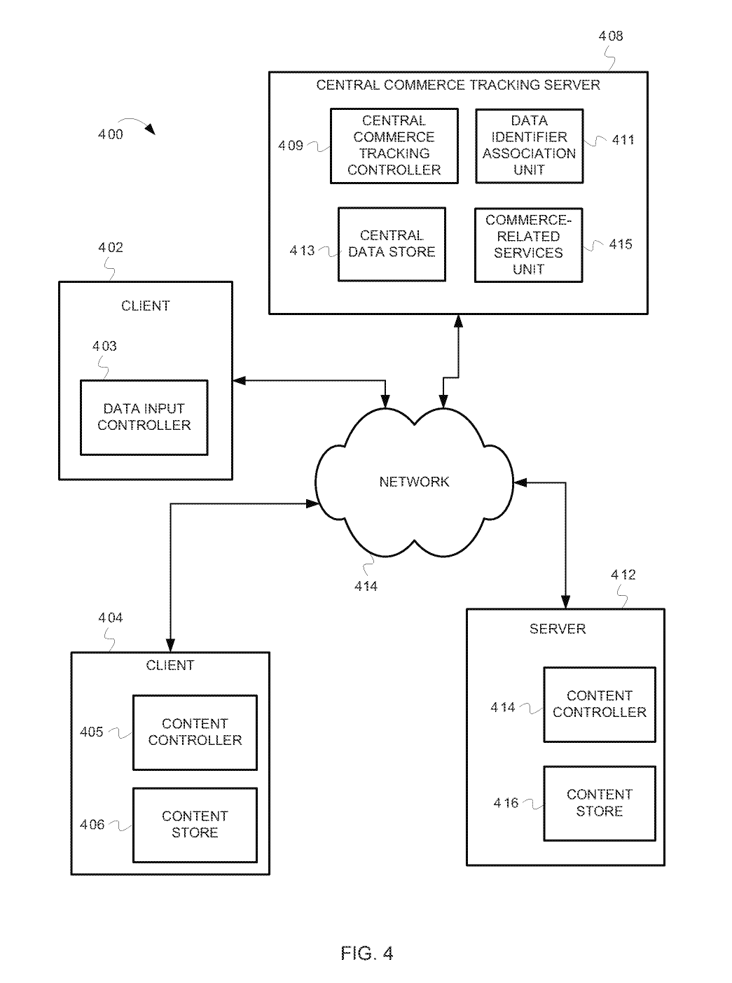

FIG. 4 is an illustration of an example commerce tracking system architecture (“system architecture”) 400. The system architecture 400 can include multiple client devices (“clients”) 402 and 404 connected to multiple servers 408 and 412 via a network 414. The network 414 can be a local area network (LAN), a wide area network (WAN), a telephone network, such as the Public Switched Telephone Network (PSTN), an intranet, the Internet, or a combination of networks or other communication pathway. For simplicity, the system architecture 400 shows only two clients 402 and 404 and two servers 408 and 412 connected to the network 414.

The server 408 may also be referred to as a central commerce tracking server. The server 408 includes a central commerce tracking controller 409. According to some embodiments, the central commerce tracking controller 409 can control electronic communications that include commerce data. The central commerce tracking controller 409 can push or pull commerce data between the server 408 and one or more of the clients 402, 404 and/or the server 412. The server 408 can also include a data identifier association unit 411. According to some embodiments, the data identifier association unit 411 can associate data identifiers for a product, a consumer, a vendor, a third party, etc. with commerce data within the central data store 413. The central data store 413 can store identifiers and commerce data as well as analysis and other content related to commerce-related services. The server 408 can also include a commerce-related services unit 415. According to some embodiments, the commerce-related services unit 415 can organize, analyze, report on, manipulate, package, present, export, or otherwise use or integrate with commerce data.

The client 402 includes a data input controller 403. According to some embodiments, the data input controller 403 can scan or otherwise track data input at a location associated with an entity. For example, the data input controller 403 may receive input from a barcode scanning laser, receive user input via a browser, upload a spreadsheet, detect a radio frequency, read data from a magnetic strip on a credit card, etc.

The client 404 includes a content controller 405 and a content store 406. According to some embodiments, the content controller 405 can present commerce-related services on a graphical user interface on a computer (e.g., in a web browser). In some embodiments, the content controller 405 can integrate with applications on the client 405 and provide the applications with information from commerce-related services provided by the server 408. According to some embodiments, the content store 405 can store content related to commerce-related services.

The server 412 includes a content controller 414 and a content store 416. According to some embodiments, the content controller 414 can track activities performed by an entity in a chain-of-commerce and provide commerce data to the server 408. According to some embodiments, the content controller 414 can also control and/or filter content (e.g., web content) for commerce-related services, and provide the content to one or more of the clients 402, 404. According to some embodiments, the content store 416 can store content and/or retrieve commerce data.

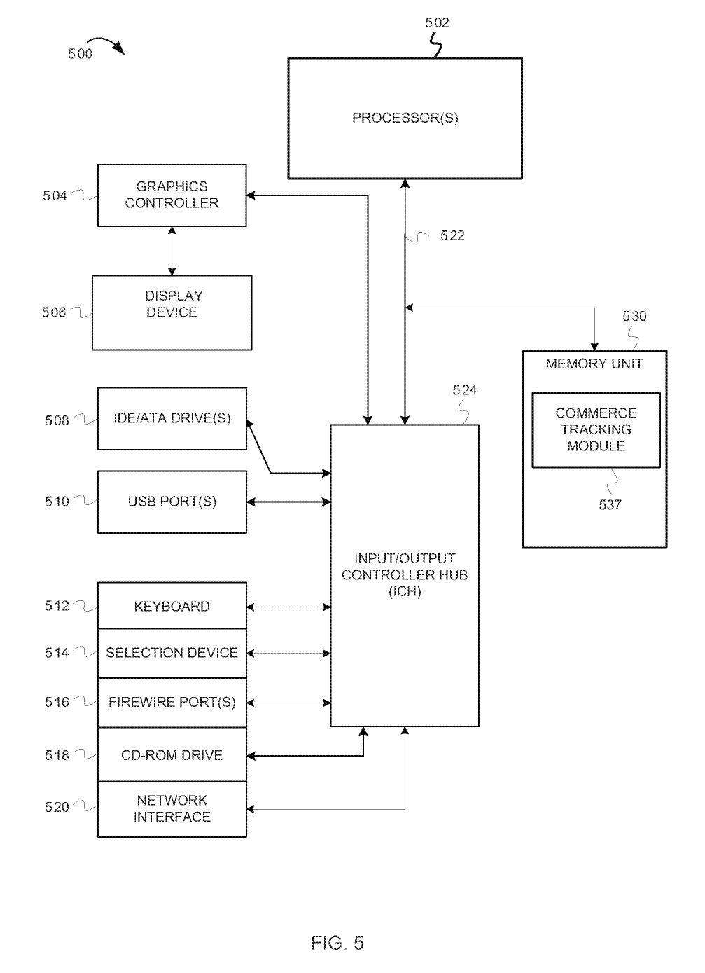

In practice, there may be a different number of clients and servers. In addition, in some instances, clients may perform the functions of servers and servers may perform the functions of clients. Any one of the clients 402, 404 and servers 408, 412 can be embodied as the computer system described in FIG. 5.

The clients 402 and 404 can be mainframes, minicomputers, personal computers, laptops, personal digital assistants, smart phones or the like. The clients 402 and 404 may transmit data over the network 414 or receive data from the network 414 via a wired, wireless, optical, or other connection. Any one or more of the components in the servers 408, 412 may be embodied in one or more client machines, possibly including one or more of the clients 402, 404. Further, any one or more of the components in the clients 402, 404 may be embodied in one or more of the servers 408, 412. For instance, servers can embody functionality (e.g., as code, a processing card, etc.) that can receive data input from product tracking devices or distributed as tasks to the clients 402, 404. For example, associating data identifiers or generating content for commerce-related services may be performed as background tasks on the client machines 402, 404 distributed by any of the servers 408 or 412.

### Example Commerce Tracking Computer System

FIG. 5 is an illustration of an example chain-of-commerce tracking computer system (“computer system”) 500. As shown in FIG. 5, the computer system 500 may include processor(s) 502, a memory unit 530, a processor bus 522, and an Input/Output controller hub (ICH) 524. The processor(s) 502, memory unit 530, and ICH 524 may be coupled to the processor bus 522. The processor(s) 502 may comprise any suitable processor architecture. The computer system 500 may comprise one, two, three, or more processors, any of which may execute a set of instructions in accordance with some embodiments.

The memory unit 530 may also include an I/O scheduling policy unit and I/O schedulers. The memory unit 530 can store data and/or instructions, and may comprise any suitable memory, such as a dynamic random access memory (DRAM), for example. The computer system 500 may also include IDE drive(s) 508 and/or other suitable storage devices. A graphics controller 504 controls the display of information on a display device 506, according to some embodiments.

The input/output controller hub (ICH) 524 provides an interface to I/O devices or peripheral components for the computer system 500. The ICH 524 may comprise any suitable interface controller to provide for any suitable communication link to the processor(s) 502, memory unit 530 and/or to any suitable device or component in communication with the ICH 524. The ICH 524 can provide suitable arbitration and buffering for each interface.

For one embodiment, the ICH 524 provides an interface to one or more suitable integrated drive electronics (IDE) drives 508, such as a hard disk drive (HDD) or compact disc read only memory (CD ROM) drive, or to suitable universal serial bus (USB) devices through one or more USB ports 510. For one embodiment, the ICH 524 also provides an interface to a keyboard 512, selection device 514 (e.g., a mouse, trackball, touchpad, etc.), CD-ROM drive 518, and one or more suitable devices through one or more firewire ports 516. For one embodiment, the ICH 524 also provides a network interface 520 though which the computer system 500 can communicate with other computers and/or devices.

The computer system 500 may also include a computer readable medium that stores a set of instructions (e.g., software) embodying any one, or all, of the methodologies for indicating energy usage at a physical site through a virtual environment. Furthermore, software can reside, completely or at least partially, within the memory unit 530 and/or within the processor(s) 502. The computer system 500 can also include a commerce tracking module 537. The commerce tracking module 537 can process communications, commands, or other information, to track and use commerce data from various stages in a chain-of-commerce. Any component of the computer system 500 can be implemented as hardware, firmware, and/or machine-readable storage media including instructions for performing the operations described herein. In some embodiments, machine-readable media/medium(s) may also be referred to as computer readable media/medium(s). Machine-readable storage media can include any suitable semiconductor memory (e.g. flash memory), magnetic media memory (e.g. a hard disk drive), organic memory media, etc.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in one or more computer readable medium(s), having computer readable program code (i.e., computer readable program instructions) embodied in the medium.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, mechanical, acoustic, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems), and computer program products according to embodiments of the invention. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments, which are defined only by the appended claims. Each of the embodiments described herein are contemplated as falling within the inventive subject matter, which is set forth in the following claims.

1. A computer-implemented method for processing information about products in a stream of commerce, the computer-implemented method comprising:
recording unique identifiers in association with products;
receiving, from a manufacturer of the products over a communications network, manufacturing information about the products;
storing, in an electronic database, the manufacturing information in association with the unique identifiers;
receiving, from entities in the stream of commerce over the communications network, additional information about the products;
storing, in the electronic database, the additional information associated with the unique identifiers;
receiving, over the communications network from retailers selling the products, consumer information identifying consumers of the products; and
storing, in the electronic database, the consumer information in association with the unique identifiers.

2. The computer-implemented method of claim 1 further comprising:
receiving, over the communications network from the manufacturer of the product, information indicating that products have been recalled;
identifying, using the unique identifiers and the consumer information, the consumers of the products; and
notifying, over the communications network, the consumers that the products have been recalled.

3. The computer-implemented method of claim 1 wherein the consumer information includes copies of transaction receipts generated in connection with sales of the products, and wherein the method further comprises:
receiving, from one of the consumers, a request for electronic copy of one of the transaction receipts; and
transmitting, to the one of the consumers over the communications network, the electronic copy of the one of the transaction receipts.

4. The computer-implemented method of claim 1 further comprising:
receiving warranty information describing a manufacturer's warranty for the products;
storing, in the electronic database, the warranty information in association with the unique identifiers; and
registering, using the unique identifiers and consumer information, the consumers for the manufacturer's warranty, wherein the registering occurs automatically after receipt of some of the consumer information.

5. The computer-implemented method of claim 1 further comprising:
receiving regulatory notifications associated with the products;
storing the regulatory notifications in the electronic database in association with the unique identifiers; and
notifying, using the unique identifiers and consumer information, the consumers about the regulatory notifications.

6. The computer-implemented method of claim 1 further comprising:
receiving offer information about one or more of discounts, rebates, retail offers, and return and exchange policies pertaining to the products;
notifying, using the unique identifiers and consumer information, the consumers about the offer information.

7. The computer-implemented method of claim 1 further comprising:
receiving a notification about a potential purchase of one of the products, wherein the notification identifies a potential consumer;
determining, based on the notification, financial spending limits associated with the potential consumer, wherein the financial spending limits are set by the potential consumer and not creditors;
determining that the potential purchase will exceed the financial spending limits if the potential purchase is completed;
presenting a notification indicating that the financial spending limits will be exceeded if the potential purchase is completed.

8. One or more machine readable storage media including instructions which, when executed on one or more processors, cause the one or more processor to execute operations comprising:
recording a product identifier that uniquely identifies a non-durable product;
receiving information about the non-durable product, wherein the information includes information about a manufacturer of the non-durable product, information about supply chain entities involved in transactions for the product, and contact information for a consumer that acquired the product;
receiving a recall notice associated with the product identifier, wherein the recall notice indicates that the non-durable product has been recalled by the manufacturer;
notifying, based on the contact information and the recall notice, the consumer that the non-durable product has been recalled by the manufacturer.

9. The one or more machine readable media of claim 8, the operations further comprising:
receiving the product identifier from the manufacturer of the non-durable product.

10. The one or more machine readable media of claim 8, the operations further comprising:
generating the product identifier; and
transmitting the product identifier to the manufacturer.

11. The one or more machine readable media of claim 8, wherein the non-durable product is not categorized as a durable product in the development of United States Gross Domestic Product statistics or as set forth by reporting entities.

12. The one or more machine readable media of claim 8, wherein the information about the non-durable product is received from systems under control of the supply chain entities.

13. The one or more machine readable media of claim 8, the operations further comprising:
receiving, from the consumer, a request for a report including the information about the non-durable product; and
transmitting the report.

14. The one or more machine readable media of claim 8, the operations further comprising:
recording, in association with the unique identifier, warranty information for the non-durable product.
notifying, using the contact information, the consumer about the warranty information.

15. A computer-implemented method comprising:
receiving, from a manufacturer one or more networks, a unique identifier that identifies a durable product;
recording, in a database, the unique identifier that identifies the durable product;
receiving, over the one or more networks, information from entities in a chain of commerce involving the durable product, wherein the information includes contact information for the entities and a consumer who acquired the durable product;
receiving, over the one or more networks, warranty information about the durable product, wherein the warranty information is associated with the unique identifier;
recording, in the database in association with the unique identifier, the warranty information and the information from the entities in the chain-of-commerce.

16. The computer-implemented method of claim 14 further comprising:
notifying, using the contact information, the consumer about the warranty information.

17. The computer-implemented method of claim 14, wherein the warranty information describes a warranty associated with the durable product, and wherein the method further comprises:
registering the consumer for the warranty.

18. The computer-implemented method of claim 14 further comprising:
receiving a recall notification associated with the unique identifier; and
using the contact information to notify the consumer about the recall notification.

19. The computer-implemented method of claim 14 wherein the information from the entities in the chain-of-commerce includes information about a retail sale of the durable product to the consumer, and wherein the method further includes:
receiving, from the consumer over the one or more networks, a request for the information about the retail sale;
providing, over the one or more networks, the information about the retail sale.

20. The computer-implemented method of claim 18, wherein the providing includes transmitting, over the one or more networks, a copy of a transaction receipt from the retail sale.
